(19) United States
(12) Patent Application Publication
(10) Pub. No.: US 2015/0373326 A1
(43) Pub. Date: Dec. 24, 2015

(54) APPARATUSES AND METHODS FOR PARAMETER SELECTION DURING RATE-DISTORTION OPTIMIZATION

(71) Applicant: MAGNUM SEMICONDUCTOR, INC., Milpitas, CA (US)

(72) Inventor: Krzysztof Hebel, Waterloo (CA)

(21) Appl. No.: 14/309,034

(22) Filed: Jun. 19, 2014

(51) Int. Cl. H04N 19/124; H04N 19/91; H04N 19/13; H04N 19/503

(52) U.S. Cl. CPC H04N 19/124; H04N 19/503; H04N 19/91; H04N 19/13

(57) ABSTRACT

Apparatuses and methods for parameter selection are disclosed. An example apparatus may include an encoder configured to receive a coding unit and to provide coefficients based on the coding unit. The encoder may further be configured to quantize the coefficients using a first quantization parameter to provide a first set of quantized coefficients and to quantize the coefficients using a second quantization parameter to provide a second set of quantized coefficients. The encoder may further be configured to provide a first rate-distortion pair based on the first set of quantized coefficients and to provide a second rate-distortion pair based on the second set of quantized coefficients. The encoder may further be configured to provide a rate-distortion curve based on the first and second rate-distortion pairs and to provide a Lagrangian parameter based on the rate-distortion curve. The encoder may be configured to encode the coding unit using the Lagrangian parameter.

### TECHNICAL FIELD

Examples described herein relate generally to video encoding, and examples of rate-distortion optimization are described.

### BACKGROUND

Video signals may be used by a variety of devices, including televisions, broadcast systems, mobile devices, and both laptop and desktop computers. Typically, devices may display video in response to receipt of video or other media signals, often after decoding the signal from an encoded form. Video signals provided between devices are often encoded using one or more of a variety of encoding and/or compression techniques, and video signals are typically encoded in a manner to be decoded in accordance with a particular standard, such as MPEG-2, MPEG-4, H.264, or HEVC. By encoding video or other media signals and decoding the received signals thereafter, the amount of data transmitted between devices may be reduced.

Video encoding typically includes individually encoding macroblocks, or other coding units, of video data. Predictive coding may be used to generate predictors and residuals, where the residual represent a difference between a predictor and the coding unit being coded. Predictive coding may include spatial and/or temporal predictions to remove redundant data in video signals, thereby further increasing the reduction in data transmitted between devices. Intracoding, for example, is directed to spatial prediction and reduces the amount of spatial redundancy between coding units within a frame or slice. Intercoding, on the other hand, is directed toward temporal prediction and reduces the amount of temporal redundancy between successive coding units, such as frames or slices. Intercoding may make use of motion prediction to track movement between successive frames or slices.

Typically, in encoder implementations, including implementations employing intracoding and intercoding, predictors and/or residuals may be transformed to provide a set of coefficients, which in turn may be quantized and entropy encoded. It is these quantized, entropy coded coefficients that may be transmitted between an encoding device and a decoding device.

Often, video encoding techniques perform some amount of rate-distortion optimization. That is, there is generally a trade-off between an achievable data rate and the amount of distortion present in a video signal. Applying coarser quantization (i.e., using a higher quantization parameter) results in a lower number of bits required to transmit the coded bitstream, but, at the same time, the quality of the reconstructed signal is lower as well (i.e., the distortion is greater). Many encoders employ rate-distortion optimization during quantization of coefficients for each residual (e.g., for each coding unit). In doing so, however, coding costs, including rate-distortion costs, must be calculated so that coefficients may be optimized. Measuring cost in this manner requires not only transformation and quantization of coefficients, but typically encoding of the coefficients as well. As a result, and in particular for more complex encoding algorithms, optimizing coefficients in real-time has presented significant challenges. Because many coding standards require highly complex and demanding computations for encoding, rate-distortion optimization which requires encoding of coefficients may simply be too demanding for completion in real-time for many existing coding standards.

### BRIEF DESCRIPTION OF THE DRAWINGS

FIG. 1 is a block diagram of an apparatus according to an embodiment of the present invention.

FIG. 2 is a schematic block diagram of an encoder according to an embodiment of the present invention.

FIG. 3 is a schematic block diagram of a parameter selection block according to an embodiment of the present invention.

FIG. 4 is a schematic block diagram of a parameter optimization block according to an embodiment of the present invention.

FIG. 5 is a schematic illustration of a media delivery system according to an embodiment of the present invention.

FIG. 6 is a schematic illustration of a video distribution system that may make use of apparatuses described herein.

### DETAILED DESCRIPTION

Examples of apparatuses and methods for parameter selection during rate-distortion optimization are disclosed herein. Certain details are set forth below to provide a sufficient understanding of embodiments of the invention. However, it will be clear to one having skill in the art that embodiments of the invention may be practiced without these particular details, or with additional or different details. Moreover, the particular embodiments of the present invention described herein are provided by way of example and should not be used to limit the scope of the invention to these particular embodiments. In other instances, well-known video components, encoder or decoder components, circuits, control signals, timing protocols, and software operations have not been shown in detail in order to avoid unnecessarily obscuring the invention.

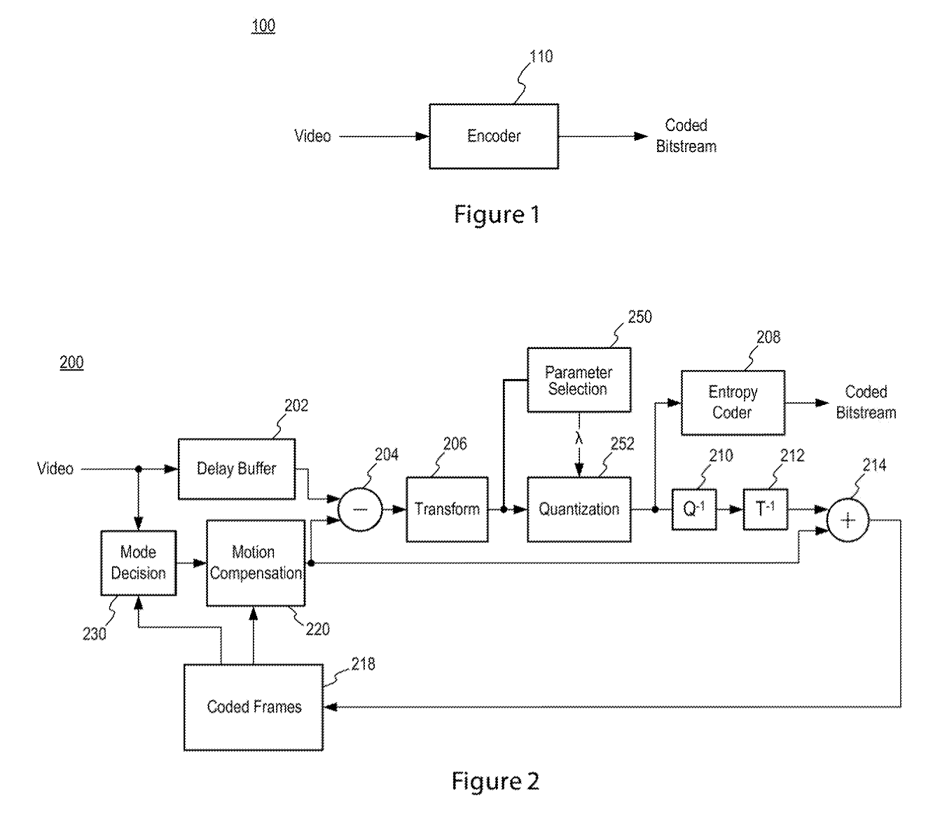

FIG. 1 is a block diagram of an apparatus 100 according to an embodiment of the present invention. The apparatus 100 may include an encoder 110. The encoder 110 may include one or more logic circuits, control logic, logic gates, processors, memory, and/or any combination or sub-combination of the same, and may encode and/or compress a video signal using one or more encoding techniques, examples of which will be described further below. The encoder 110 may encode, for example, a variable bit rate signal and/or a constant bit rate signal, and generally may operate at a fixed rate to output a bitstream that may be provided in a rate-independent manner. The encoder 110 may be implemented in any of a variety of devices employing video encoding, including, but not limited to, televisions, projectors, broadcast systems, mobile devices, tablets, and both laptop and desktop computers.

In at least one embodiment, the encoder 110 may include an entropy coder, such as a variable-length coding coder (e.g., Huffman encoder, VLC encoder, CAVLC/CABAC encoder), and/or may encode data, for instance, at a macroblock level or at a level of another coding unit. In some embodiments, each macroblock may be encoded according to a frame type. For example, each macroblock may be encoded in intra-coded mode, inter-coded mode, bidirectionally, or in any combination or subcombination of the same in accordance with a frame type.

By way of example, the encoder 110 may receive and encode a video signal, e.g., video data, which includes a plurality of sequentially ordered coding units (e.g., block, macroblock, slice, frame, field, group of pictures, sequence). A video signal may include a transient signal, stored data, or both. The video signal may be encoded in accordance with one or more encoding standards, such as MPEG-2, MPEG-4, H.263, H.264 and/or H.265/HEVC, to provide a coded bitstream. The coded bitstream may in turn be provided to a data bus and/or to a device, such as a decoder or transcoder (not shown in FIG. 1), for instance, directly or via a transmission medium.

Generally, the encoder 110 may encode a video signal to optimize one or more aspects of the video signal, such as rate-distortion. In one embodiment, for example, the encoder 110 may optimize rate and/or distortion of a video signal by optimizing quantized coefficients during an encoding process. Rate-distortion optimization may refer to a process designed to select a particular rate-distortion trade-off where a sufficient rate is maintained with an allowable amount of distortion. A rate-distortion cost, or “RD score,” may typically be determined by multiplying a rate by a Lagrangian parameter lambda (λ) and adding the product to a distortion. Additionally or alternatively, a rate-distortion cost may be determined by multiplying distortion by the inverse of a Lagrangian parameter lambda (λ⁻¹) and adding the product to the rate. Typically, encoding methods may aim to minimize rate-distortion costs. However, the optimization process may include selecting an RD score other than an absolute minimum RD score in some examples.

As will be explained in more detail below, the encoder 110 may perform rate-distortion optimization by encoding each coding unit of the video signal in accordance with Lagrangian optimization. By way of example, for each coding unit of a video signal, the encoder 110 may perform multiple encodes of the coding unit using multiple quantization parameters (QP) and/or values of lambda. For each encode, the encoder 110 may provide (e.g., generate) data indicative of the rate and/or distortion for encoding the coding unit. Typically, the encodes may be performed in parallel, though in some examples whether two or more of the encodes are performed in parallel may depend on available computational resources. Based on the data, the encoder 110 may provide an optimal lambda and may subsequently encode the coding unit using the optimal lambda to provide a rate-distortion optimized coded bitstream. The initial encodes of the coding unit using multiple quantization parameters and/or values of lambda may be performed using a less computationally intensive encoding methodology than the final encode used to generate the rate-distortion optimized coded bitstream. For example, each of the initial encodes may rely on rate and distortion estimation instead of entropy encoding.

FIG. 2 is a schematic block diagram of an encoder 200 according to an embodiment of the invention. The encoder 200 may be used to implement the encoder 110 of FIG. 1, and may further be compliant with one or more coding standards, such as the MPEG-2 or H.264. In some embodiments, the encoder 200 may additionally or alternatively be partially or fully compliant with one or more other coding standards known in the art, now or in the future, such as HEVC.

The encoder 200 may include a mode decision block 230, a motion compensation block 220, a delay buffer 202, a subtractor 204, a transform 206, a quantization block 252, a parameter selection block 250, an entropy coder 208, an inverse quantization block 210, an inverse transform block 212, an adder 214, and a coded frames buffer 218. The mode decision block 230 may determine one or more appropriate coding modes based, at least in part, on an incoming video signal and coded frame buffer signal, described further below, and/or may determine each coding mode on a per frame and/or macroblock basis. Additionally, the mode decision block 230 may employ motion and/or disparity estimation of the video signal. The mode decision may include macroblock type, intra modes, inter modes, motion vectors, and/or quantization parameters.

The output of the mode decision block 230 may be utilized by the motion compensation block 220 to generate a predictor in accordance with a coding standard, such as the MPEG-2 coding standard and/or other prediction methodologies. The predictor may be subtracted from a delayed version of the video signal at the subtractor 204. Using the delayed version of the video signal may provide time for the mode decision block 230 to operate. The output of the subtractor 204 may be a residual, e.g., the difference between a block and a predicted block, and the residual may be provided to the transform 206.

The transform 206 may perform a transform, such as a discrete cosine transform (DCT), to transform the residual to the frequency domain. As a result, the transform 206 may provide a coefficient block that may, for instance, correspond to one or more spectral components of the video signal.

The parameter selection block 250 may receive the coefficient block and provide lambda based on the coefficient block. As described, providing lambda in this manner may include determining rates and/or distortions that may result from encoding coefficients of the coefficient block using multiple quantization parameters and/or values of lambda. As described, in at least some examples, respective rates and/or distortions may be determined in parallel. Lambda may be determined per macroblock or per any other coding unit level (e.g., a portion of a macroblock) in some examples.

The quantization block 252 may also receive the coefficient block from the transform 206 and further may receive lambda from the parameter selection block 250. The quantization block 252 may quantize the coefficients of the coefficient block to produce a quantized coefficient block. The quantization employed by the quantization block 252 may be lossy, but may adjust and/or optimize one or more coefficients of the coefficient block based on lambda. By way of example, the quantization block 252 may quantize the coefficients using lambda to achieve the optimal rate-distortion tradeoff.

In turn, the entropy coder 208 may encode the quantized coefficient block to provide an encoded bitstream. The entropy coder 208 may be any entropy coder known by those having ordinary skill in the art, such as a context-adaptive variable length coding (CAVLC) coder or context-adaptive binary arithmetic coding (CABAC) coder.

As discussed, the encoder 200 may operate in accordance with any known video coding standard, including the MPEG-2 video coding standard. Thus, because many video standards, including the MPEG-2 video coding standard, employ motion prediction and/or compensation, the encoder 200 may further include a feedback loop that includes an inverse quantization block 210, an inverse transform 212, and a reconstruction adder 214. These elements may mirror elements included in a decoder (not shown) configured to reverse, at least in part, the encoding process performed by the encoder 200. Additionally, the feedback loop of the encoder may include a motion compensation block 220 and a coded frame buffer 218. In particular, the optimized quantized coefficients may be inverse scaled and inverse quantized by the inverse quantization block 210. The inverse scaled and quantized coefficients may be inverse transformed by the inverse transform 212 to produce a reconstructed residual. The reconstructed residual may be added to the predictor at the adder 214 to produce reconstructed video, written to the coded frame buffer 218 for use in future frames, and fed back to the mode decision block 230 for further in-macroblock intra prediction or other mode decision operations.

In an example operation of the encoder 200, a video signal (e.g. a base band video signal) may be provided to the encoder 200. The video signal may be provided to the delay buffer 202 and the mode decision block 230. The subtractor 204 may receive the video signal from the delay buffer 202 and may subtract a motion prediction signal from the video signal to generate a residual. The residual may be provided to the transform 206 and processed using a transform (e.g., forward transform), such as a DCT. As described, the transform 206 may generate a coefficient block that may be provided to the parameter selection block 250, and the parameter selection block 250 may provide lambda based on the coefficient block. In at least some examples, lambda may be optimized for encoding coefficients of the coefficient block.

The quantization block 252 may receive the coefficient block and lambda, and may quantize and/or optimize the coefficient block such that the cost (e.g., rate-distortion cost) of coefficients in the coefficient block is optimized. In one embodiment, quantization of the coefficient block may be employed using lambda or, in some examples, using the inverse lambda (e.g., lambda is used as a rate weighting factor and inverse lambda is used as a distortion weighting factor). The quantized coefficient block may be provided to the entropy coder 208 and the entropy coder 208 may encode the quantized coefficient block to provide a coded bitstream.

The quantized coefficient block may further be provided to the feedback loop of the encoder 200. That is, the quantized coefficient block may be inverse quantized, inverse transformed, and added to the motion prediction signal by the inverse quantization block 210, the inverse transform 212, and the reconstruction adder 214, respectively, to produce a reconstructed video signal. The coded frame buffer 218 may receive a reconstructed video signal from the reconstruction adder 214, and using the buffered frame signals, the motion compensation block 220 may provide a motion prediction signal to the subtractor 204.

Accordingly, the encoder of FIG. 2 may provide a coded bitstream based on a video signal, where the coded bitstream is generated using coefficients optimized in accordance with embodiments of the present invention. The coded bitstream may, for instance, be a CABAC or CAVLC bitstream that may operate at a fixed rate. The encoder may be operated in semiconductor technology, and may be implemented in hardware, software, or combinations thereof. In some examples, the encoder may be implemented in hardware with the exception of the mode decision block that may be implemented in software. In other examples, other blocks may also be implemented in software, however software implementations may not achieve real-time operation in some examples.

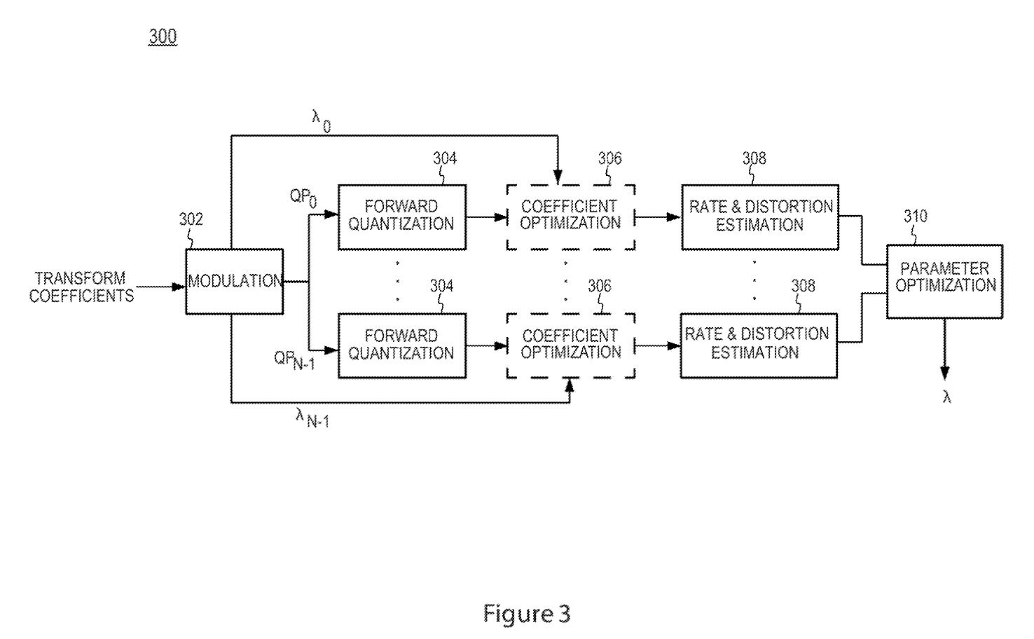

FIG. 3 is a schematic block diagram of a parameter selection block 300 according to an embodiment of the present invention. The parameter selection block 300 may be used to implement the parameter selection block 250 of FIG. 2. The parameter selection block 300 may include a modulation block 302, forward quantization blocks 304, coefficient optimization blocks 306, rate and distortion estimation blocks 308, and a parameter optimization block 310.

The modulation block 302 may receive coefficients of a coefficient block, for instance, from a transform such as the transform 206 of FIG. 2, and provide the coefficients to each of the forward quantization blocks 304. The modulation block 302 may further provide (e.g., generate) a plurality of quantization parameters, each of which may be provided to a respective forward quantization block 304. The plurality of quantization parameters may comprise a range or set of values, and further may have a particular average and/or median value (e.g., average frame QP, macroblock QP). In some examples, the plurality of quantization parameters may be based on the coefficients of the coefficient block and/or may be specified by a component of an encoder, such as a mode decision block. The modulation block 302 may further provide a plurality of lambda values, each of which may be provided to a respective coefficient optimization block 306. The lambda values may include a range or set of values, and further may have a particular average and/or median value. In some examples, the plurality of lambda values may be based on the coefficients of the coefficient block and/or may be specified by a component of an encoder, such as a mode decision block. Additionally or alternatively, in other examples, the plurality of lambda values may be based on the plurality of quantization parameters supplied by the modulation block 302, for instance, according to a fixed relationship.

Each of the forward quantization blocks 304 may receive the coefficients and a respective quantization parameter from the modulation block 302 and quantize the coefficients using the received quantization parameter. In this manner, each forward quantization block 304 may provide a respective set of quantized coefficients to a corresponding coefficient optimization block 306.

Each of the coefficient optimization blocks 306 may receive a respective set of quantized coefficients from a corresponding forward quantization block 304 and a respective lambda from the modulation block 302 and optimize the set of quantized coefficients using lambda. Optimizing the quantized coefficients in this manner may include, for instance, varying one or more of the quantized coefficients to determine a best rate-distortion cost associated with the received lambda. In some examples, each coefficient optimization block 306 may optimize the quantized coefficients using dynamic programming and/or trellis-based optimizations, or may optimize the quantized coefficients by “zeroing out” one or more of the quantized coefficients. Each coefficient optimization block 306 may provide a set of optimized coefficients to a corresponding rate and distortion estimation block 308.

Each rate and distortion estimation block 308 may receive a respective set of optimized coefficients and determine a rate and a distortion (rate-distortion pair) for encoding the optimized coefficients. Each of the rate and distortion estimation blocks 308 may estimate rates and/or distortions using one or more known estimation techniques. Rates, for instance, may be determined in accordance with look-up tables and/or functions associated with one or more particular coding standards (e.g., entropy coding standards). Distortions may be determined using one or more known techniques, including but not limited to sum of absolute differences (SAD), sum of squared differences (SSD), structural similarity indexing (SSI), or combinations thereof. In other examples, each of the rate and distortion estimation blocks 308 may encode (e.g., fully encode) a respective set of optimized coefficients to determine respective rates and/or distortions. Fully encoding optimized coefficients in this manner may include applying entropy coding, calculating a number of bits utilized for the entropy encoding, and/or applying a reconstruction process. Each rate-distortion pair may be provided to the parameter optimization block 310, and in turn, the parameter optimization block 310 may provide lambda for optimizing the coefficients based on one or more of the rate-distortion pairs, described in further detail below.

In this manner, the parameter selection block 300 may perform multiple encodings on coefficients associated with a coding unit to provide a Lagrangian parameter lambda. In particular, for each of a plurality of quantization parameters and/or lambdas, coefficients may be quantized, optimized, and/or used to provide rate-distortion pairs. Thereafter, the respective rate-distortion pairs may be used to provide lambda. As described, lambda may be used for optimizing rate-distortion during quantization of coefficients. In some examples, rate-distortion pairs may be determined in parallel. For example, coefficients may be quantized, optimized, and used to determine rate-distortion pairs simultaneously, concurrently, and/or in an otherwise overlapping manner. In other examples, rate-distortion pairs may be determined serially.

In some embodiments, the parameter selection block 300 may include additional components or omit one or more of the described components. By way of example, the parameter selection block 300 may omit coefficient optimization blocks 306 such that each forward quantization block 304 provides quantized coefficients to a corresponding rate and distortion estimation block 308. In this manner, the parameter selection block 300 need not optimize quantized coefficients. In other examples, each of the coefficient optimization blocks 306 may be selectively enabled, for instance by a mode decision block, such that quantized coefficients may be selectively optimized by one or more of the coefficient optimization blocks 306.

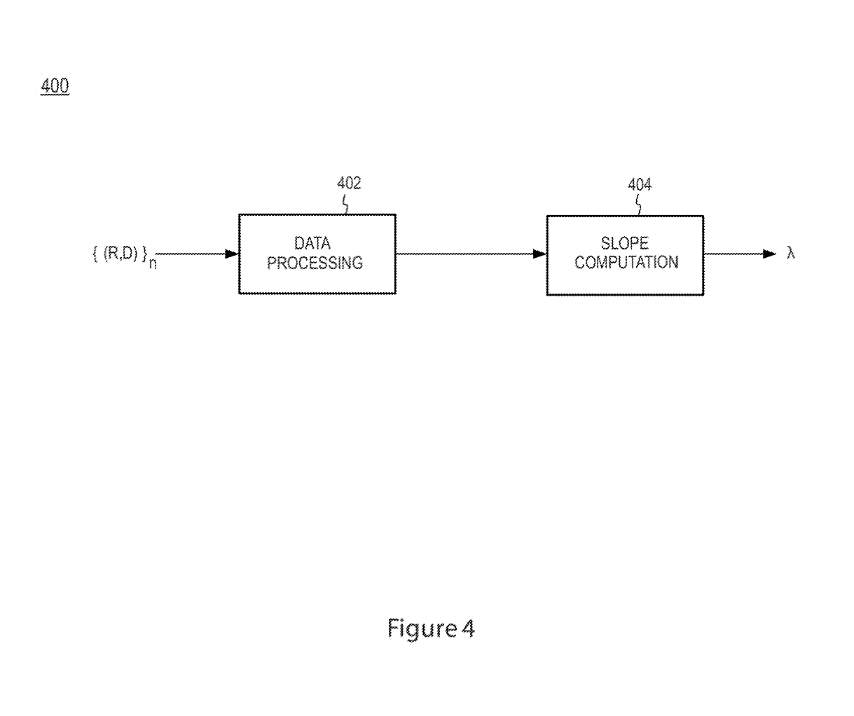

FIG. 4 is a schematic block diagram of a parameter optimization block 400 according to an embodiment of the present invention. The parameter optimization block 400 may be used to implement the parameter optimization block 310 of the parameter selection block 300 of FIG. 3. The parameter optimization block 400 may include a data processing block 402 and a slope computation block 404.

Briefly, the data processing block 402 and slope computation block 404 may serve to provide lambda. In some embodiments, the data processing block 402 may receive a rate and a distortion from each of a plurality of rate and distortion estimation blocks, such as the rate and distortion estimation blocks 308 of FIG. 3. As described, each received rate and distortion may correspond to the rate and distortion for encoding a same coding unit using respective quantization parameters and/or values of lambda. In some examples, each rate and distortion received in this manner may include a rate-distortion pair that may, for instance, be used as a datum or data point of a data set. Accordingly, the plurality of received rates and distortions may make up a set of rate-distortion pairs which may be used to provide a curve, and in some examples a curve fitting methodology may be used to provide the curve fitted to the rate-distortion pairs. Lambda may be provided based on the curve.

The data processing block 402 may receive each of the rate-distortion pairs and adjust one or more rates and distortions and/or provide one or more additional rate-distortion pairs to include in the set of rate-distortion pairs. Additional rate-distortion pairs may, for instance, be interpolated from the rate-distortion pairs provided by the cost estimation blocks 308.

The slope computation block 404 may receive each of the rate-distortion pairs from the data processing block 402 and provide a curve based on the rate-distortion pairs. In some examples, the slope computation block 404 may employ linear regression to provide a curve (e.g., a line) based on to each of the rate-distortion pairs, and the slope of the curve may be used as a value of lambda. Lambda, therefore, may be determined in accordance with the following equation:

$$λ = \vert \frac{{Σ}_{i = 0}^{n - 1} {R}_{i} {Σ}_{i = 0}^{n - 1} {D}_{i} - n {Σ}_{i = 0}^{n - 1} {R}_{i} {D}_{i}}{{( {Σ}_{i = 0}^{n - 1} {R}_{i} )}^{2} - n {Σ}_{i = 0}^{n - 1} {R}_{i}^{2}} \vert$$

where λ represents lambda, n represents the number of rate-distortion pairs, and Ri and Di represent the rate and the distortion of the ith rate-distortion pair, respectively. Thus, employing linear regression in this manner may include providing a curve in accordance with the covariance of the rates and distortions and the variance of the rates. Lambda may comprise the absolute value of the result.

In another example, lambda may be provided using polynomial curve fitting. The slope computation block 404 may employ polynomial curve fitting to provide a curve based on the rate-distortion pairs. The curve may be used by the slope computation block 404 to estimate a slope of a tangent to the curve at a given point, and the identified slope may be provided as lambda for a corresponding rate and/or distortion. In some examples, the given point may be selected based on a particular rate or distortion and/or content being encoded. Because a slope may have a negative value, in some examples, the slope computation block 404 may provide an absolute value of a slope. Once lambda has been determined, the slope computation block 404 may provide lambda to a quantization block, such as the quantization block 252 of FIG. 2.

In some examples, the slope computation block 404 may selectively implement linear regression or polynomial curve fitting. By way of example, the slope computation block 404 may determine whether to use linear regression or polynomial curve fitting based on one or more of the rate-distortion pairs, and/or may determine whether to use linear regression or polynomial curve fitting based on the computational resources required for each approach.

Generally, examples described herein are directed to providing lambda, for instance, to optimize rate-distortion processes. In some examples, lambda may be provided to optimize mode decisions. For example, a coding unit may be encoded as described herein for each of a plurality of modes (e.g., intra, skip, one or more inter modes) such that a respective lambda is provided for each mode. Each lambda may then be used to determine a rate-distortion cost for encoding the coding unit. The mode associated with the lowest overall rate-distortion cost may be selected for encoding the coding unit. Selecting a mode in this manner may be implemented, for instance, using a mode decision block, or may be implemented in one or more pre-processing stages of an encoder.

In another example, lambda may be provided to optimize frame/field encoding. For example, a coding unit may be encoded as described herein using each of frame (progressive) encoding and field (interlaced) encoding, such that a lambda is provided for each of frame encoding and field encoding. Each lambda may then be used to determine a rate-distortion cost for frame encoding and field encoding the coding unit. The encoding method associated with the lowest rate-distortion cost may be used for encoding the coding unit. Selecting frame encoding or field encoding may be implemented using a mode decision block, or may be implemented in one or more pre-processing stages of an encoder. By way of example, a picture adaptive frame/field (PAFF) decision block may be used to select either frame encoding or field encoding.

Moreover, while examples herein are directed to providing lambda for a particular coding unit, in some examples, lambda may be provided for multiple coding units simultaneously by way of a joint optimization process. A plurality of coding units may, for instance, be used to estimate lambda for the plurality of coding units. Coding units of any level may be jointly optimized, including, but not limited to, blocks, macroblocks, frames, fields, pictures, slices, and groups of pictures. In some examples, adjacent coding units may be jointly optimized, though it will be appreciated that any number of coding units in any arrangement may be jointly optimized. Joint optimization may be implemented in any application employing lambda, including, but not limited to, examples directed to quantization, mode decisions, and frame/field encoding, described herein.

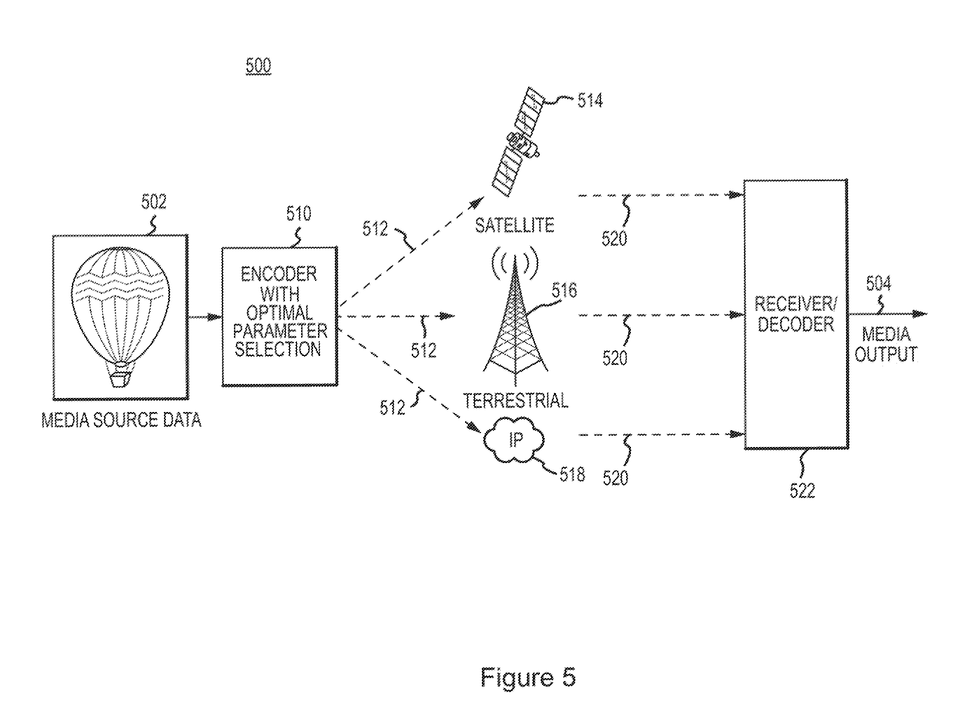

FIG. 5 is a schematic illustration of a media delivery system 500 in accordance with embodiments of the present invention. The media delivery system 500 may provide a mechanism for delivering a media source 502 to one or more of a variety of media output(s) 504. Although only one media source 502 and media output 504 are illustrated in FIG. 5, it is to be understood that any number may be used, and examples of the present invention may be used to broadcast and/or otherwise deliver media content to any number of media outputs.

The media source data 502 may be any source of media content, including but not limited to, video, audio, data, or combinations thereof. The media source data 502 may be, for example, audio and/or video data that may be captured using a camera, microphone, and/or other capturing devices, or may be generated or provided by a processing device. Media source data 502 may be analog and/or digital. When the media source data 502 is analog data, the media source data 502 may be converted to digital data using, for example, an analog-to-digital converter (ADC). Typically, to transmit the media source data 502, some mechanism for compression and/or encryption may be desirable. Accordingly, an apparatus 510 may be provided that may filter and/or encode the media source data 502 using any methodologies in the art, known now or in the future, including encoding methods in accordance with video standards such as, but not limited to, MPEG-2, H.264, HEVC, or combinations of these or other encoding standards. The apparatus 510 may be implemented with embodiments of the present invention described herein. For example, the apparatus 510 may be implemented using the apparatus 100 of FIG. 1.

The encoded data 512 may be provided to a communications link, such as a satellite 514, an antenna 516, and/or a network 518. The network 518 may be wired or wireless, and further may communicate using electrical and/or optical transmission. The antenna 516 may be a terrestrial antenna, and may, for example, receive and transmit conventional AM and FM signals, satellite signals, or other signals known in the art. The communications link may broadcast the encoded data 512, and in some examples may alter the encoded data 512 and broadcast the altered encoded data 512 (e.g. by re-encoding, adding to, or subtracting from the encoded data 512). The encoded data 520 provided from the communications link may be received by a receiver 522 that may include or be coupled to a decoder. The decoder may decode the encoded data 520 to provide one or more media outputs, with the media output 504 shown in FIG. 5. The receiver 522 may be included in or in communication with any number of devices, including but not limited to a modem, router, server, set-top box, laptop, desktop, computer, tablet, mobile phone, etc.

The media delivery system 500 of FIG. 5 and/or the apparatus 510 may be utilized in a variety of segments of a content distribution industry.

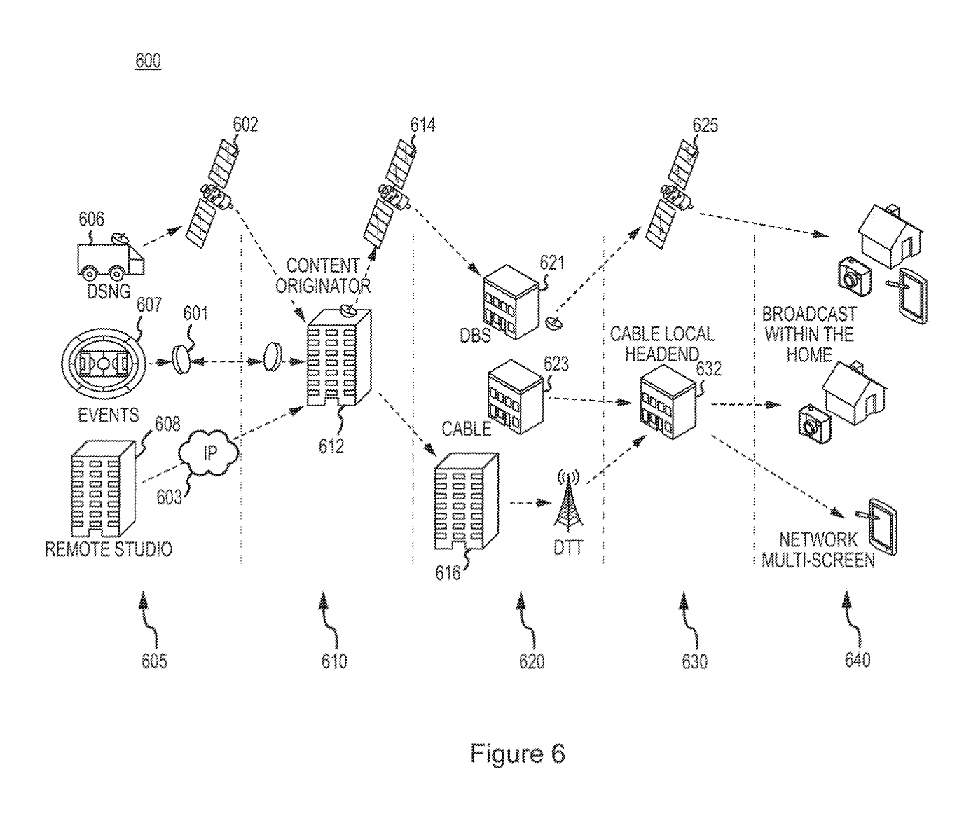

FIG. 6 is a schematic illustration of a video distribution system 600 that may make use of apparatuses described herein. The video distribution system 600 includes video contributors 605. The video contributors 605 may include, but are not limited to, digital satellite news gathering systems 606, event broadcasts 607, and remote studios 608. Each or any of these video contributors 605 may utilize an apparatus described herein, such as the apparatus 100 of FIG. 1, to encode media source data and provide encoded data to a communications link. The digital satellite news gathering system 606 may provide encoded data to a satellite 602. The event broadcast 607 may provide encoded data to an antenna 601. The remote studio 608 may provide encoded data over a network 603.

A production segment 610 may include a content originator 612. The content originator 612 may receive encoded data from any or combinations of the video contributors 605. The content originator 612 may make the received content available, and may edit, combine, and/or manipulate any of the received content to make the content available. The content originator 612 may utilize apparatuses described herein, such as the apparatus 100 of FIG. 1, to provide encoded data to the satellite 614 (or another communications link). The content originator 612 may provide encoded data to a digital terrestrial television system 616 over a network or other communication link. In some examples, the content originator 612 may utilize a decoder to decode the content received from the contributor(s) 605. The content originator 612 may then re-encode data and provide the encoded data to the satellite 614. In other examples, the content originator 612 may not decode the received data, and may utilize a transcoder to change a coding format of the received data.

A primary distribution segment 620 may include a digital broadcast system 621, the digital terrestrial television system 616, and/or a cable system 623. The digital broadcasting system 621 may include a receiver, such as the receiver 522 described with reference to FIG. 5, to receive encoded data from the satellite 614. The digital terrestrial television system 616 may include a receiver, such as the receiver 522 described with reference to FIG. 5, to receive encoded data from the content originator 612. The cable system 623 may host its own content which may or may not have been received from the production segment 610 and/or the contributor segment 605. For example, the cable system 623 may provide its own media source data 502 as that which was described with reference to FIG. 5.

The digital broadcast system 621 may include an apparatus, such as the apparatus 510 described with reference to FIG. 5, to provide encoded data to the satellite 625. The cable system 623 may include an apparatus, such as the apparatus 100 of FIG. 1, to provide encoded data over a network or other communications link to a cable local headend 632. A secondary distribution segment 630 may include, for example, the satellite 625 and/or the cable local headend 632.

The cable local headend 632 may include an apparatus, such as the apparatus 100 of FIG. 1, to provide encoded data to clients in a client segment 540 over a network or other communications link. The satellite 625 may broadcast signals to clients in the client segment 640. The client segment 640 may include any number of devices that may include receivers, such as the receiver 522 and associated decoder described with reference to FIG. 5, for decoding content, and ultimately, making content available to users. The client segment 640 may include devices such as set-top boxes, tablets, computers, servers, laptops, desktops, cell phones, etc.

Accordingly, filtering, encoding, and/or decoding may be utilized at any of a number of points in a video distribution system. Embodiments of the present invention may find use within any, or in some examples all, of these segments.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An apparatus, comprising:
an encoder configured to receive a coding unit and to provide coefficients based on the coding unit, the encoder further configured to quantize the coefficients using a first quantization parameter to provide a first set of quantized coefficients and to quantize the coefficients using a second quantization parameter to provide a second set of quantized coefficients, the encoder further configured to provide a first rate-distortion pair based on the first set of quantized coefficients and to provide a second rate-distortion pair based on the second set of quantized coefficients, the encoder further configured to provide a rate-distortion curve based on the first and second rate-distortion pairs and to provide a Lagrangian parameter based on the rate-distortion curve;
wherein the encoder is further configured to encode the coding unit using the Lagrangian parameter.

2. The apparatus of claim 1, wherein the Lagrangian parameter is a first Lagrangian parameter, and wherein the encoder is further configured to optimize the first set of quantized coefficients using a second Lagrangian parameter.

3. The apparatus of claim 1, wherein the Lagrangian parameter is based on a slope of the rate-distortion curve.

4. The apparatus of claim 3, wherein the Lagrangian parameter is based on an absolute value of the slope of the rate-distortion curve.

5. The apparatus of claim 1, wherein the first quantization parameter is specified by a mode decision.

6. The apparatus of claim 1, wherein the encoder is configured to quantize coefficients associated with the coding unit using the Lagrangian parameter.

7. The apparatus of claim 1, wherein the encoder is further configured to provide the rate-distortion curve using linear regression, polynomial curve fitting, or combinations thereof.

8. An encoder, comprising:
a parameter selection block configured to provide a plurality of rate-distortion pairs based on a set of coefficients, each of the rate-distortion pairs indicative of a rate and a distortion for encoding the set of coefficients with a respective quantization parameter, the parameter selection block further configured to provide a Lagrangian parameter based on the plurality of rate-distortion pairs; and
a quantization block coupled to the parameter selection block and configured to receive the Lagrangian parameter, the quantization block configured to quantize the set of coefficients based on the Lagrangian parameter.

9. The encoder of claim 8, wherein the parameter selection block is further configured to quantize the set of coefficients using each of the plurality of quantization parameters.

10. The encoder of claim 9, wherein the parameter selection block is configured to provide a rate-distortion curve based on each of the plurality of rate-distortion pairs.

11. The encoder of claim 8, further comprising:
a mode decision block configured to provide the plurality of quantization parameters.

12. The encoder of claim 8, wherein the Lagrangian parameter is based on a slope of a rate-distortion curve, the rate-distortion curve based on the plurality of rate-distortion pairs.

13. The encoder of claim 12, wherein the rate-distortion curve is based on at least one of linear regression or polynomial curve fitting.

14. A method, comprising:
providing, using an encoder, coefficients of a coding unit of a video signal;
performing a plurality of encodes of the coefficients to provide a plurality of rate-distortion pairs, each of the encodes performed using a respective quantization parameter;
providing a rate-distortion curve based on the plurality of rate-distortion pairs; and
providing a Lagrangian parameter, the Lagrangian parameter corresponding to a slope of the rate-distortion curve.

15. The method of claim 14, wherein performing a plurality of encodes of the coefficients to provide a plurality of rate-distortion pairs comprises:
optimizing quantized coefficients, the quantized coefficients based on the coefficients.

16. The method of claim 15, wherein optimizing quantized coefficients comprises:
optimizing the quantized coefficients based on a plurality of Lagrangian parameters.

17. The method of claim 15, wherein optimizing quantized coefficients comprises:
optimizing the quantized coefficients using dynamic programming.

18. The method of claim 14, wherein providing a rate-distortion curve based on the plurality of rate-distortion pairs comprises:
providing a rate-distortion curve based on the plurality of rate-distortion pairs using linear regression, polynomial curve fitting, or combinations thereof.

19. The method of claim 18, providing a Lagrangian parameter comprises:
determining an absolute value of the slope of the rate-distortion curve.

20. The method of claim 14, further comprising:
quantizing the coding unit based on the Lagrangian parameter.

21. The method of claim 14, further comprising:
determining, using a mode decision block, a mode for encoding the coding unit based on the Lagrangian parameter.
